(19) United States
(12) Patent Application Publication
(10) Pub. No.: US 2011/0222296 A1
(43) Pub. Date: Sep. 15, 2011

(54) REFLECTOR

(75) Inventor: Martin KIRSTEN, Burscheid (DE)

(73) Assignee: BA*RO GmbH & Co. KG, Leichlingen (DE)

(21) Appl. No.: 13/039,460

(22) Filed: Mar. 3, 2011

(30) Foreign Application Priority Data
Mar. 10, 2010 (DE) 20 2010 003 436.1

(51) Int. Cl. F21V 7/04

(52) U.S. Cl. 362/298; 362/346

(57) ABSTRACT

The present invention relates to a reflector for producing an elliptical light image, which is elongate in form, defines a reflector axis (X) and has pairs of side wall reflectors (3) and face wall reflectors (4) lying opposite one another which on their lower side delimit a light outlet opening, the face side reflectors (4) and the side wall reflectors (3) being in the form of simply spherically curved reflector segments, the reflector segments (3, 4) of each pair of reflectors having the same curvature radius, and the angle of inclination α enclosed by the face wall reflectors (4) in the longitudinal section with the reflector axis (X) being 1.5 to 3 times as large as the angle of inclination β enclosed by the side wall reflectors (3) with the reflector axis (X).

The present invention relates to a reflector for producing an elliptical light image which is elongate in form, defines a reflector axis and has pairs of side wall reflectors and face wall reflectors lying opposite one another which on their lower side delimit a light outlet opening. Furthermore, the invention relates to a light with this type of reflector.

In order to produce elliptical light images different forms of light can be used. First and foremost lights are used the reflectors of which are symmetrical in two planes. Here the side wall reflectors are formed with a double spherical curve, i.e. they have a spherical curvature both in the longitudinal section and in the cross-section, whereas the face wall reflectors are level in form. With these types of reflector point light sources or spatially extended light sources are used which stand in the light centre of the reflector. Furthermore, in order to illuminate elongate areas such as, for example, sales counters, so-called bat wing reflectors are also used in which, for example, halogen vapour lamps are used in a horizontal lighting position as illuminants.

The known lights have by all means proved to be of value in practice, but attempts are being made to provide alternative lights with which elongate areas such as, for example, sales counters or fruit stands, which have a rectangular, elongated form, can be illuminated, and which at the same time are easy and inexpensive to produce and to maintain.

Therefore, it is the object of the present invention to provide a light and a reflector of the type specified at the start with which elongate areas can be illuminated, and which are easy and inexpensive to produce and to maintain.

According to the invention this object is achieved with a light of the type specified at the start in that the illuminant is in the form of a Lambert light emitter with a circular area provided on the upper side of the reflector, directed at the light outlet opening, and emitting light according to a Lambert characteristic, and that the face wall reflectors and the side wall reflectors are in the form of simply spherically curved reflector segments, the reflector segments of each pair of reflectors having the same curvature radius, and the angle of inclination α enclosed by the face wall reflectors in the longitudinal section with the reflector axis being 1.5 to 3 times as large as the angle of inclination β enclosed by the side wall reflectors with the reflector axis.

Therefore, the lights according to the invention are equipped with a Lambert light emitter as an illuminant which has a circular area provided on the upper side of the reflector and emitting light according to a Lambert characteristic. These Lambert light emitters, known in their own right, are inexpensive to produce and to use, in particular if they are based upon LED technology. In order to bring the light emitted circularly by the Lambert light emitter into the desired elongate form, according to the invention a reflector is provided the side wall reflectors and face wall reflectors of which are formed simply spherically curved, i.e. those in a cross-sectional plane lying perpendicularly to the reflector axis have a spherical curvature, whereas those in the longitudinal section are level in form. Provision is made here such that the face wall reflectors are positioned more flatly than the side wall reflectors, the angle of inclination α enclosed by the side wall reflectors in the longitudinal section with the reflector axis being approximately 1.5 to 3 times, and in particular approximately 2 times as large as the angle of inclination β enclosed by the side wall reflectors with the reflector axis. Preferably, the angle of inclination α is approximately 30° and the angle of inclination β is approximately 15 to 20°, in particular approximately 17°. It has been shown that with this design elongate areas can be illuminated evenly.

The simply curved reflector segments can be produced simply, for example from aluminium sheet. By choosing the dimensions appropriately the desired radii of curvature are automatically set when the reflector segments are connected to one another at their upper and lower end regions. For this purpose connecting hooks, for example that can be engaged with one another on the reflector segments, can be provided. Therefore, the reflector designed according to the invention is also easy and inexpensive to produce.

Preferably, the reflector segments can be in the form of mirror reflectors with a reflection-enhancing surface.

According to one embodiment of the invention provision is made such that the angle of inclination β of the side wall reflectors is chosen such that the mirror image of the radiating circular area of the Lambert light emitter is at least 90% visible for an observer who is looking into the reflector from below in the direction of the reflector axis. By means of this design a maximum light strength below the light is achieved.

Furthermore, the reflector height can be chosen such that an imaginary line from a lower edge region of the reflector to the opposite upper edge region of the reflector encloses an angle x≧60° with the reflector axis. With this design dazzling effects are reliably avoided.

In a further development of the invention provision can be made such that the ratio of the surface area of the side wall reflectors to the surface area of the side wall reflectors is approximately 2:1.

Furthermore, the arrangement can preferably be made such that the Lambert radiator fills the area lying between the reflector segments on the upper side of the reflector by at least 85%, and in particular by at least 90%.

Finally, a holder for attaching the Lambert light emitter and/or for fixing the light to a wall or similar can be provided on the upper side of the reflector.

With regard to a further advantageous embodiment of the invention, reference is made to the sub-claims and to the following description of an exemplary embodiment with reference to the attached drawings. The drawings show as follows:

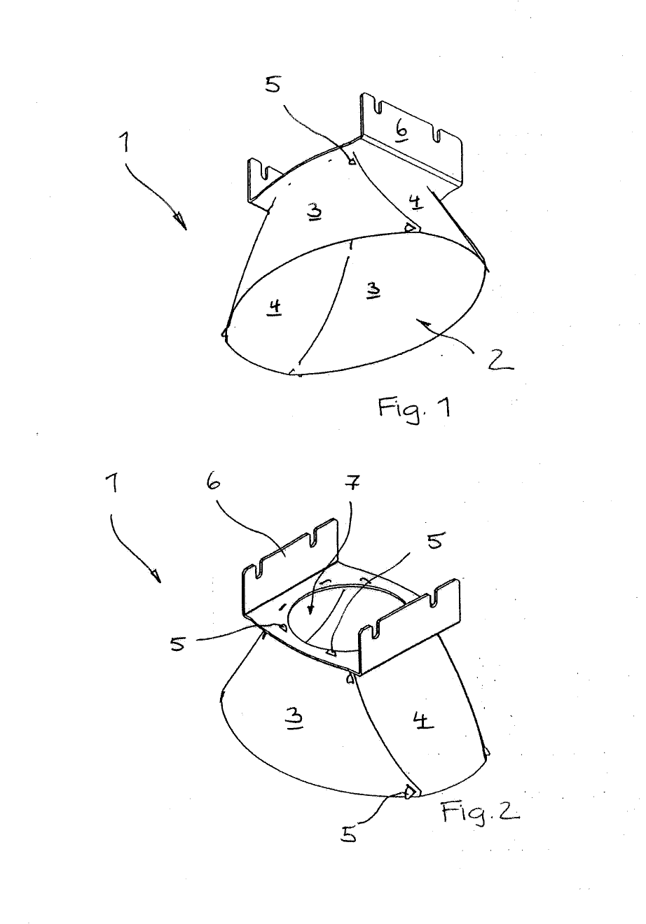

FIG. 1 a perspective view of a reflector of a light according to the invention;

FIG. 2 the reflector of FIG. 1 in a further perspective view;

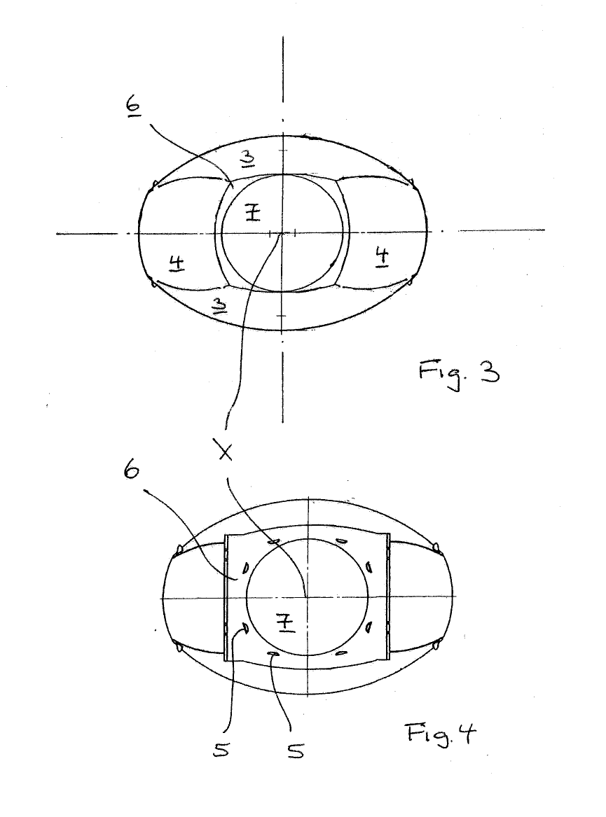

FIG. 3 the reflector of FIG. 1 viewed from below;

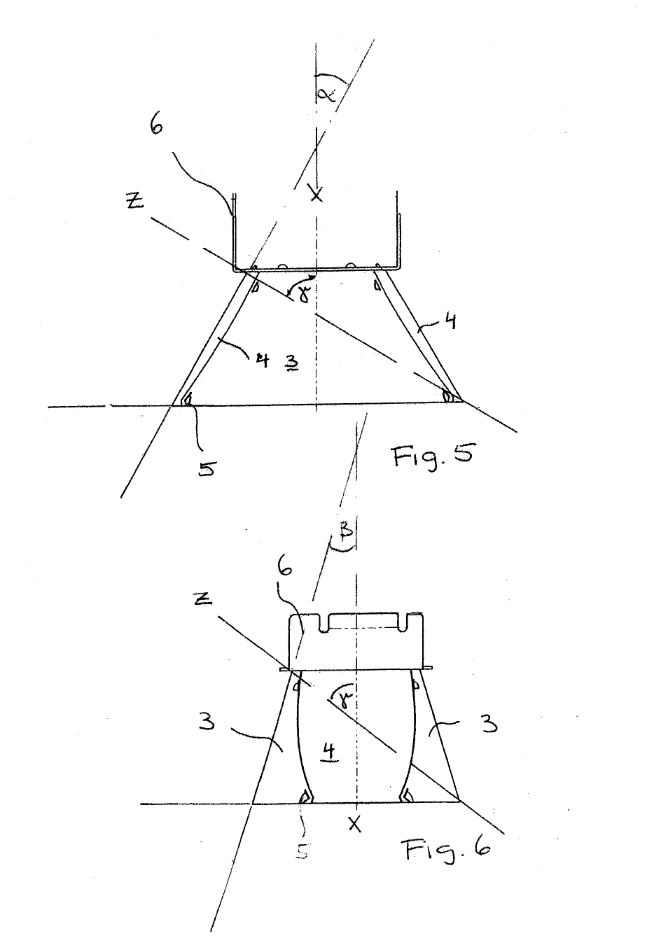

FIG. 4 a top view of the reflector of FIG. 1;

FIG. 5 a side view of the reflector;

FIG. 6 a front view of the reflector;

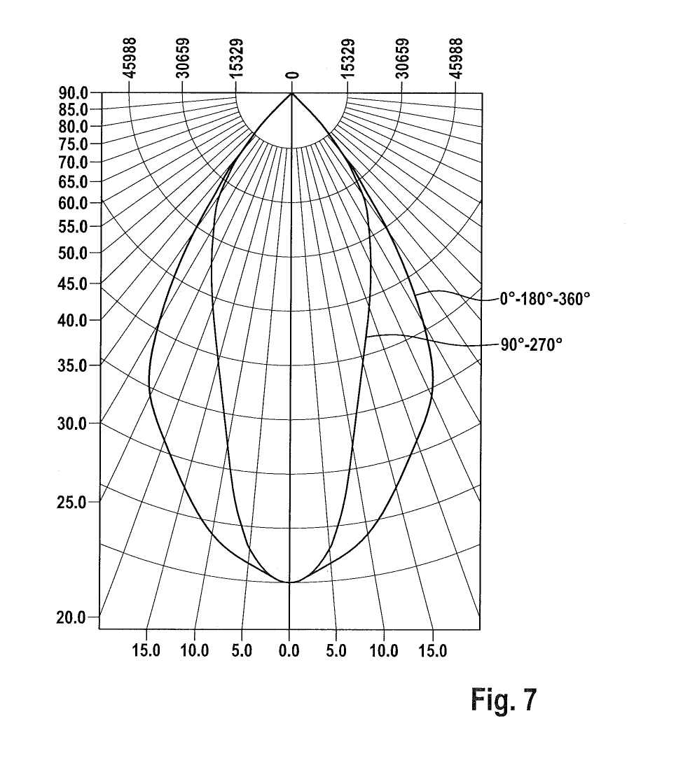

FIG. 7 a polar diagram of the light strength distributions of a light according to the invention;

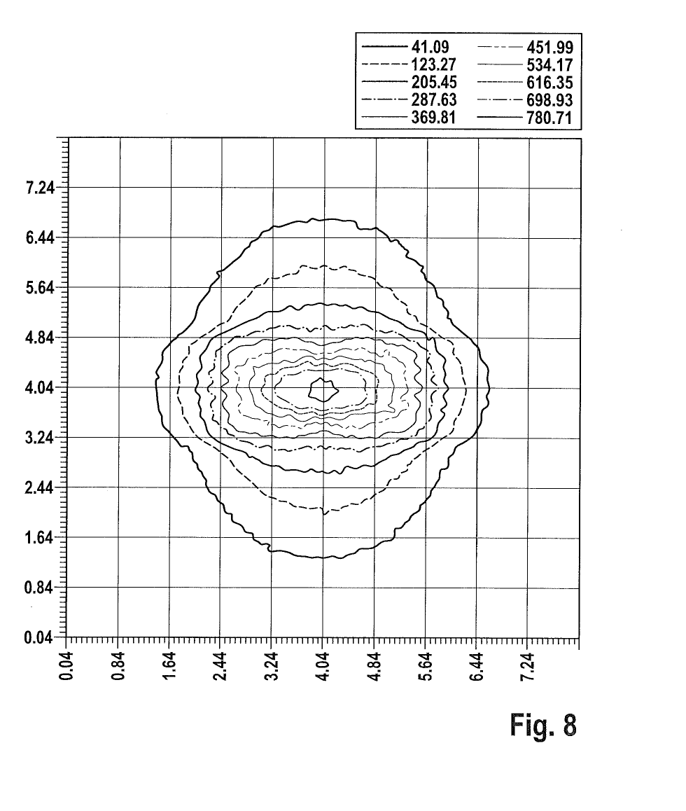

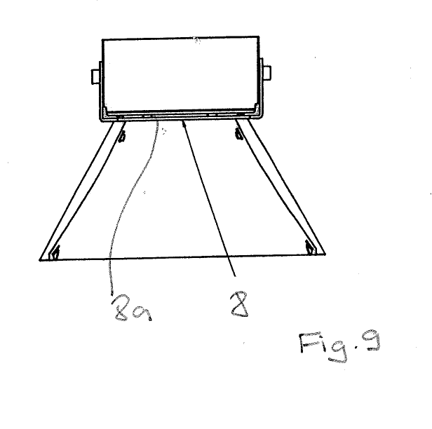

FIG. 8 an isolux diagram of the light strength distribution of a light according to the invention; and

FIG. 9 a side view corresponding to FIG. 5 depicting the reflector with a Lambert light emitter mounted thereon.

The drawing shows a reflector 1 of a light according to the invention for producing an elliptical light image. The reflector 1 has an open under side which forms a light outlet opening 2 of the reflector 1, and an open upper side, the reflector 1 defining a reflector axis X extending centrally between the upper side and the lower side. As can be seen well in the drawing, the reflector 1 is formed by two pairs of side wall reflectors 3 and face wall reflectors 4 lying opposite one another, which are respectively in the form of simply spherically curved reflector segments 3, 4. In other words, the reflector segments 3, 4 have in a cross-sectional plane lying perpendicularly to the reflector axis X a spherical curvature (see FIGS. 3 and 4), whereas in the longitudinal section they are level in form, as shown by the side views of FIGS. 5 and 6.

In the embodiment shown the side wall reflectors 3 and the face wall reflectors 4 are formed by discrete reflector segments which lie next to one another in the circumferential direction and are connected to one another on their upper and lower end region. For this purpose connection elements 5 are provided on the reflector segments 3, 4 which can be engaged with one another, in this instance hooked together. The reflector segments 3, 4 are produced from aluminium sheet and have reflection-enhancing surfaces. Here the reflector segments 3, 4 are formed so thinly that they can be curved elastically from the flat sheet form into the spherical form. The reflector segments 3, 4 are formed here such that the desired radii of curvature are set automatically when the reflector segments 3, 4 are connected to one another at their upper and lower end regions.

Attached to the open upper side of the reflector 1 is a holder 6 which serves to fix the light to a wall or similar. Moreover, the holder 6 is provided for attaching an illuminant. In practice, as an illuminant a Lambert light emitter 8 (shown in FIG. 9) is used which has a circular area 8a emitting light according to a Lambert characteristic and which is directed downwardly. In order to hold this circular light emitting area a circular opening 7 is provided in the holder 6.

It can be seen well in the drawing that the face wall reflectors 4 are positioned more flatly than the side wall reflectors 3. In practice, the angle of inclination α enclosed by the face wall reflectors 4 in the longitudinal section with the reflector with the reflector axis is 30°, and the angle of inclination β enclosed by the side wall reflectors 3 with the reflector axis X is approximately 17°, whereby the angle of inclination α is approximately twice as large as the angle of inclination β.

As shown in FIGS. 5 and 6, the reflector height h is chosen such that an imaginary line z from the lower edge region of the reflector 1 to the opposite upper end region of the reflector 1 encloses an angle x≧60° with the reflector axis X. With these embodiments dazzling effects of the reflector 1 are reliably avoided.

Furthermore, the angles of inclination α, β of the spherical side wall reflectors 3 and the face wall reflectors 4, the reflector height h and the outer dimensions of the reflector are chosen such that the mirror image of the radiating, circular area of a fitted Lambert light emitter is at least 90% visible for an observer looking into the reflector 1 from below in the direction of the reflector axis X.

Finally, in FIGS. 7 and 8 the light distribution curves are shown which are achieved with the light according to the invention.

1. A reflector for producing an elliptical light image which, the reflector being elongate in form, defining a reflector axis (X) and having pairs of side wall reflectors (3) and face wall reflectors (4) lying opposite one another which on their lower side delimit a light outlet opening (2), characterised in that the face side reflectors (4) and the side wall reflectors (3) are in the form of simply spherically curved reflector segments, the reflector segments (3, 4) of each pair of reflectors having the same curvature radius, and the angle of inclination α enclosed by the face wall reflectors (4) in the longitudinal section with the reflector axis (X) being 1.5 to 3 times as large as the angle of inclination β enclosed by the side wall reflectors (3) with the reflector axis (X).

2. The reflector according to claim 1, characterised in that the ratio of the angles of inclination α, β is approximately 2 (α/β=approximately 2).

3. The reflector according to claim 1, characterised in that the angle of inclination α is approximately 30° and the angle of inclination β is approximately 15 to 20°.

4. The reflector according to claim 1, characterised in that the reflector height h is chosen such that an imaginary line z from a lower edge region of the reflector (1) to the opposite upper edge region of the reflector (1) encloses an angle x≧60° with the reflector axis (X).

5. The reflector according to claim 1, characterised in that the ratio A of the surface area of the side wall reflectors (3) to the surface area of the face wall reflectors (4) is at least 2:1 (A≧1.5).

6. The reflector according to claim 1, characterised in that the reflector segments (3, 4) are in the form of mirror reflectors with a reflection-enhancing surface.

7. The reflector according to claim 1, characterised in that on the upper side of the reflector a holder (6) is provided for attaching a Lambert light emitter (8) and/or for fixing the reflector to a wall or similar.

8. Light for producing an elliptical light image with an elongate reflector (1) which defines a reflector axis (X) and has pairs of side wall reflectors (3) and face wall reflectors (4) lying opposite one another which on their lower side delimit a light outlet opening (2), and having an illuminant (8), characterised in that the illuminant is in the form of a Lambert light emitter (8) with a circular area (8a) provided on the upper side of the reflector (1), directed at the light outlet opening (2), and emitting light according to a Lambert characteristic, and that the reflector (1) is formed according to claim 1.

9. The light according to claim 8, characterised in that the angle of inclination β of the side wall reflectors (3) is chosen such that the mirror image of the light emitting circular area (8a) of the Lambert light emitter (8) is at least 90% visible for an observer looking into the reflector (1) from below in the direction of the reflector axis (X).

10. The light according to claim 8, characterised in that the Lambert light emitter (8) fills the area lying between the reflector segments (3, 4) on the upper side of the reflector (1) by at least 85%, in particular by at least 90%.
